(19) United States
(12) Patent Application Publication
(10) Pub. No.: US 2005/0025381 A1
(43) Pub. Date: Feb. 3, 2005

(54) Image filter method

(76) Inventors: Munenori Oizumi, Ibaraki (JP); Osamu Koshiba, Ibaraki (JP); Hiroki Yamaguchi, Tokyo (JP)

Correspondence Address: TEXAS INSTRUMENTS INCORPORATED, P O BOX 655474, M/S 3999, DALLAS, TX, 75265, US

(21) Appl. No.: 10/632,322

(22) Filed: Aug. 1, 2003

(51) Int. Cl. G06K 9/40

(52) U.S. Cl. 382/264

(57) ABSTRACT

Pre-process an image to be compressed with a DCT-based compression method by by filtering with a filter defined by local modified horizontal and vertical auto-correlations to suppress artifacts related to items such as edges between bright and dark planes.

### CROSS-REFERENCE TO RELATED APPLICATIONS

The following patent applications disclose related subject matter: application Ser. No. 09/______, filed ______ (______). These referenced applications have a common assignee with the present application.

### BACKGROUND OF THE INVENTION

The invention relates to image processing, and more particularly to image filtering methods and related devices such as digital and video cameras.

There has been considerable growth in the sale and use of digital cameras, both still and video, in recent years. FIG. 4 is a block diagram of a typical digital still camera which includes various image processing components, collectively referred to as an image pipeline. Color filter array (CFA) interpolation, gamma correction, white balancing, color space conversion, and JPEG (or MPEG for video) compression-decompression constitute some of the key image pipeline processes.

In DCT-based video/image compression, such as MPEG or JPEG, a low bit rate (high compression) for efficient transmission or storage is known to cause annoying artifacts, such as mosquito-noise, block noise, etc. In order to reduce these artifacts, preprocessing of input images is required. However, conventional linear filtering often reduces the detail clarity as well as the artifacts in the output signal. However, the size of such filters becomes large when the desired characteristics are demanding, and this results in prohibitively large circuit size.

Infinite impulse resonse (IIR) filtering is often used in acoustical signal processing. However, it is little used in image processing due to its side effects, which are often imperceptible in sound but apparent in images.

Filtering using the matching method compares input signals with a stored database and outputs appropriate signals. Although this method works well in some situations, the output quality can be low if the database does not match the input. Also, this method consumes large amounts of memory and computational power.

### SUMMARY OF THE INVENTION

The present invention provides image preprocessing methods and systems with filtering using estimates of the power spectrum distribution of the input image by the auto-correlation and applies appropriate filtering accordingly.

This has advantages including enhanced quality of DCT-based image compression.

### BRIEF DESCRIPTION OF THE DRAWINGS

The drawings are heuristic for clarity.

FIGS. 1a-1b are a flow diagram for a preferred embodiment method and a preferred embodiment digital camera system.

FIGS. 2a-2b illustrate artifacts.

FIGS. 3-5 show compression for various textures.

FIGS. 6-7 show preferred embodiment metric characteristics.

FIGS. 8a-8c illustrate preferred embodiment metric distortion indication.

FIG. 9 shows preferred method pre-processing and compression.

FIGS. 10-13 compare preferred embodiment methods with prior art methods.

### DETAILED DESCRIPTION OF THE PREFERRED EMBODIMENTS

1. Overview

Preferred embodiment image filtering methods include two steps: the first step evaluates the local characteristics of the image, and the second applies filtering to the local area according to the result of evaluation. In particular, boundaries between bright and dark planes show the most annoying artifacts when DCT processed with high-frequency quantization; so the preferred embodiments locally smooth such boundaries while leaving areas with low-variability intensity and areas with high-variability intensity unsmoothed. The preferred embodiments detect boundaries between bright and dark by noting that the power spectrum of such boundaries (in the continuous variable case) decays roughly like 1/ω where ω is the spatial frequency, whereas the low-variability power spectrum decays roughly like 1/ω² or faster, and the high-variability power spectrum is roughly constant.

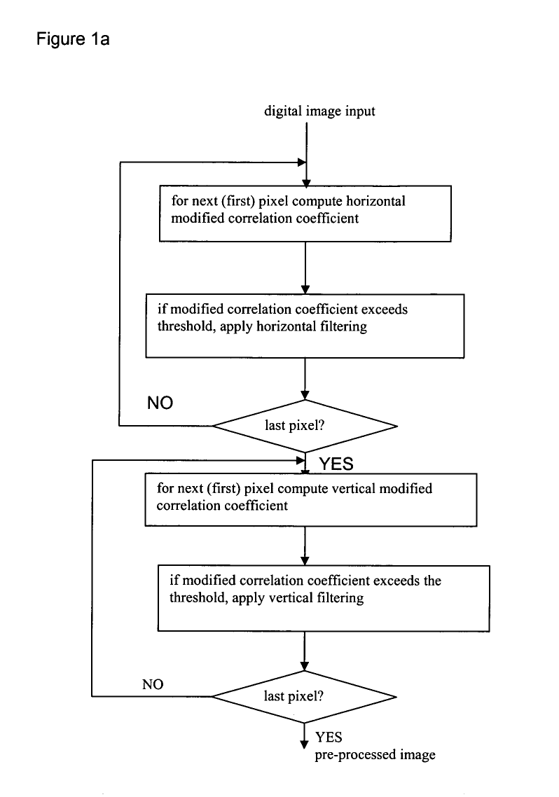

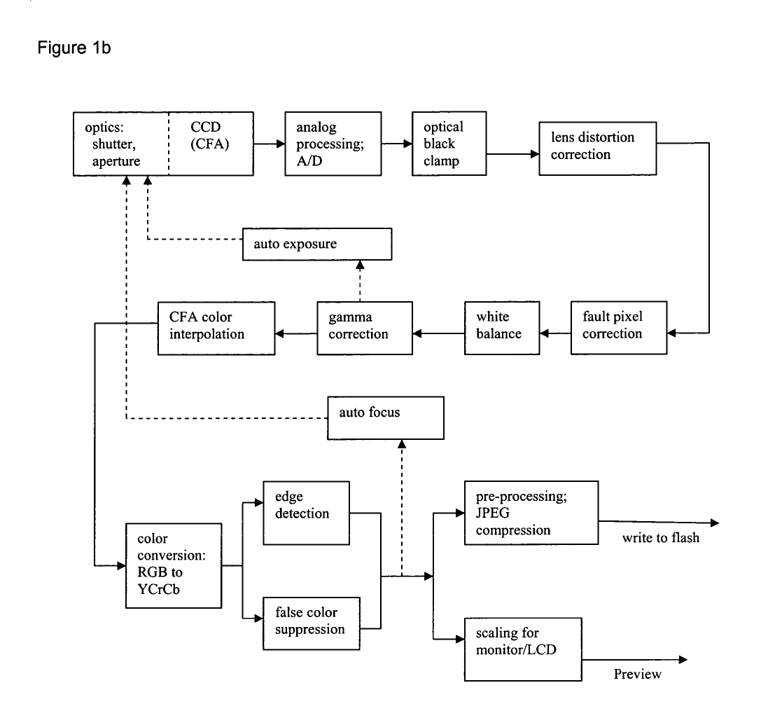

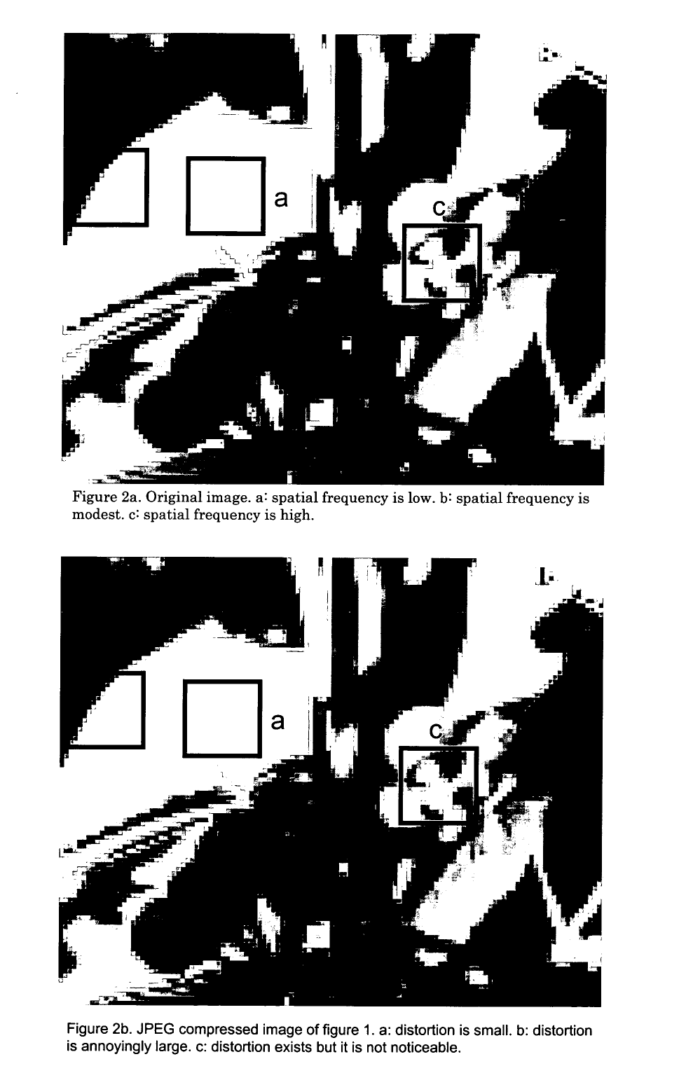

FIG. 1a is a flow diagram for a preferred embodiment method. The methods allow a relatively simple computation, a modified correlation coefficient, to determine pre-processing filtering to suppress DCT-base compression artifacts.

Preferred embodiment digital image systems (such as cameras) include preferred embodiment image pre-processing filtering methods. FIG. 1b shows in functional block form a system (digital still camera) which incorporates preferred embodiment methods as shown in the JPEG compression block. The functions of preferred embodiment systems can be performed with digital signal processors (DSPs) or general purpose programmable processors or application specific circuitry or systems on a chip such as both a DSP and RISC processor on the same chip with the RISC processor as controller. Further specialized accelerators, such as CFA color interpolation and JPEG encoding, could be added to a chip with a DSP and a RISC processor. Captured images could be stored in memory either prior to or after image pipeline processing. The image pipeline functions could be a stored program in an onboard or external ROM, flash EEPROM, or ferroelectric RAM for any programmable processors.

2. DCT-Based Compression Artifacts

This section briefly reviews artifacts in DCT-based compression, and the analysis of the origin of artifacts is described.

FIGS. 2a-2b show examples of artifacts in 8×8 block DCT-based compression. FIG. 2a is the original (uncompressed) image and FIG. 2b is the compressed (JPEG) image. Various distortions are visible in FIG. 2b. By closely examining distortion in various images, including this figure, the following characteristics have been discovered.

(a) Artifacts are very small where spatial variation is small (see box “a” in FIGS. 2a-2b).

(b) Distortion is large at the boundary of bright plane and dark plane (see box “b” in FIGS. 2a-2b).

(c) Artifacts exist, but are not noticeable, in complex texture. (see box “c” in FIGS. 2a-2b).

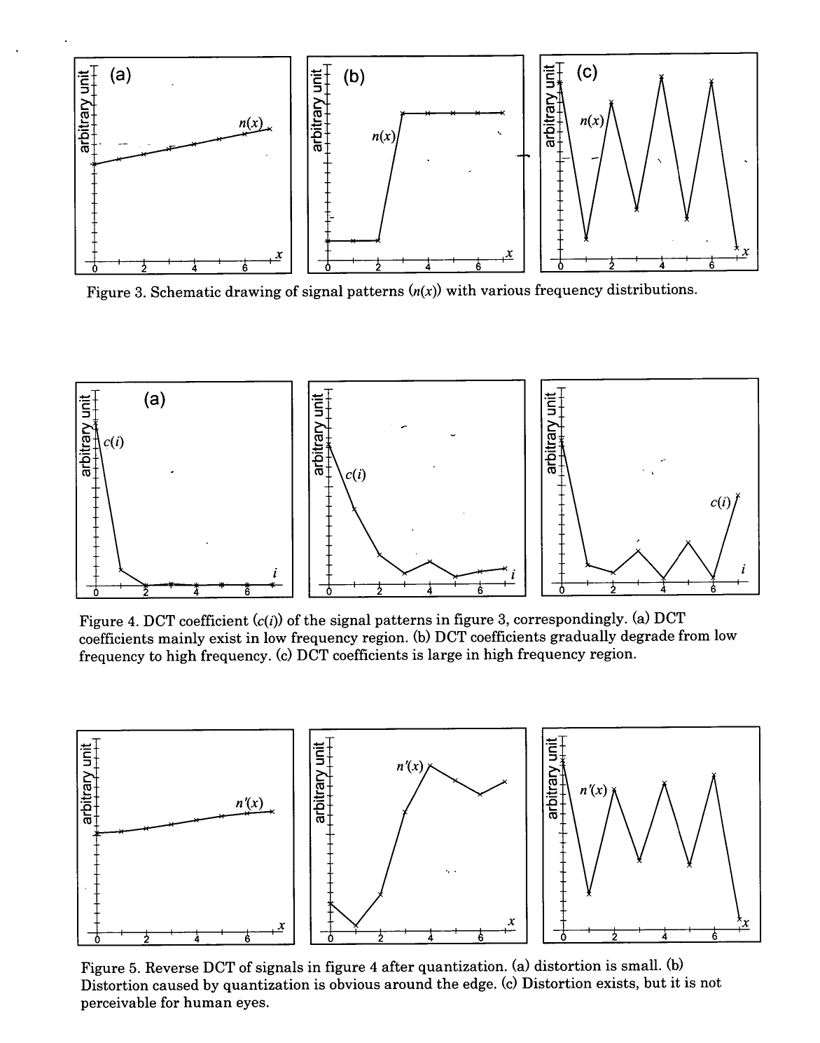

A schematic picture of each (intensity) signal pattern (horizontal or vertical through one of the boxes) is shown in FIG. 3, and their corresponding DCT coefficient signals are shown in FIG. 4. Here, the signal is x(n) (n=0, 1, . . . , 7), and the DCT coefficients are defined as.

$$c ( k ) = \sqrt{\frac{2}{N}} C ( k ) {\sum }_{n} x ( n ) cos ( \frac{( 2 n + 1 ) k π}{2 N} ) , C ( k ) = \{ \begin{matrix}1 / 2 & k = 0 \\ 1 & k \neq 0\end{matrix} . \qquad ( 1 )$$

Also, the corresponding compressed sptial signals (inverse DCT after quantization) are shown in FIG. 5.

By comparing FIGS. 3 and 5, it is obvious that the pattern (b) generates the most annoying distortions. Observation of DCT coefficients of each signal pattern (FIG. 4) indicates that this symptom is caused by the size of the quantization level. In DCT-based compression, the quantization level is larger in high frequency regions. Therefore, high frequency components are most affected. From FIG. 4, the following tendencies can be found for the patterns.
Pattern (a): High frequency coefficients are negligibly small.
Pattern (b): Coefficients gradually degrades as frequency increases.
Pattern (c): High frequency coefficients are large.
   In pattern (b) the high frequency components are distorted by the quantization level because the coefficients are small. However, pattern (a) shows small distortion because the coefficients are negligible anyway. On the other hand, coefficients in pattern (c) are larger than the quantization level, resulting in small distortion. Apparently, this is the reason why the distortion is most obvious in pattern (b). Note that if the DC component were removed, then pattern (a) would be very small at all frequencies, pattern (b) would be primarily low frequencies, and pattern (c) would be primarily high frequencies.

Based on the above, the preferred embodiment method strategy is.
(1) Find the pixels with surrounding blocks having patterns similar to the pattern (b) in FIGS. 3-4.
(2) Apply low pass filtering at these pixels.
   In the following sections, each step is explained in detail.
   3. Power Spectrum and Auto-Correlation

In this section, the mathematical analysis of power spectrum is explained for continuous variables. Then, a metric to measure the shape of the power spectrum, which underlies the preferred embodiment methods, is introduced.

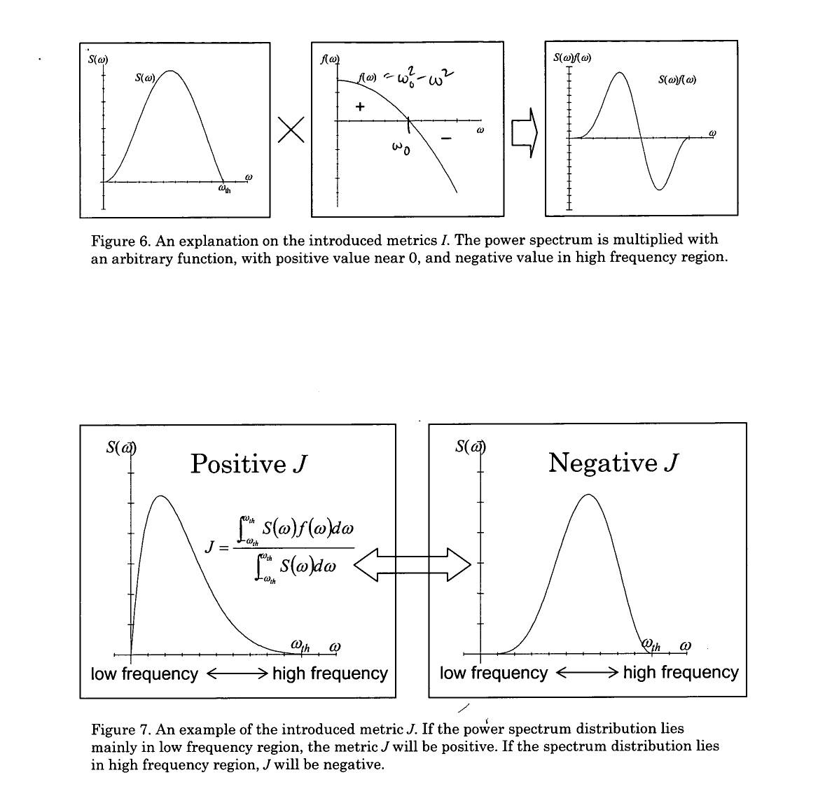

The schematic picture of a power spectrum is shown in FIG. 6. It is assumed that the spectrum is confined to −ωₜₕ<ω<ωₜₕ. Also, the spatial average of the signal is assumed to be zero; that is, remove any DC component, prior to the following calculations.

In order to evaluate the distribution of the spectrum, introduce a metric, J, which measures the distribution of a power spectrum:

$$J = \frac{{\int }_{- {ω}_{th}}^{{ω}_{th}} S ( ω ) f ( ω ) ⅆ ω}{{\int }_{- {ω}_{th}}^{{ω}_{th}} S ( ω ) ⅆ ω} = \frac{I}{{I}_{0}} . \qquad ( 2 )$$

where f(ω) is an arbitrary function which shows positive values near ω=0, and negative values near ω=ωₜₕ (see FIG. 6). If the power spectrum distribution lies primarily in the low frequency region, the combined signal S(ω))f(ω) distribution lies in the low frequency regions with positive values, and J will be positive (see FIG. 7). Contrarily, if the power spectrum distribution lies primarily in the high frequency regions, the combined signal S(ω)f(ω) distribution lies in the high frequency regions with negative values, and J will be negative. In short,
primarily low frequency S(ω) implies positive J.
primarily high frequency S(ω) implies negative J.
   Thus the immediate objective is to evaluate J to find the distribution of the power spectrum.

With f(ω))=ω₀²−ω² (illustrated in FIG. 6), I becomes:

$$\begin{matrix}I = {\int }_{- {ω}_{th}}^{{ω}_{th}} S ( ω ) ( {ω}_{0}^{2} - {ω}^{2} ) ⅆ ω \\ = {ω}_{0}^{2} {\int }_{- {ω}_{th}}^{{ω}_{th}} S ( ω ) ⅆ ω - {\int }_{- {ω}_{th}}^{{ω}_{th}} {ω}^{2} S ( ω ) ⅆ ω\end{matrix} \qquad ( 3 )$$

Next, introduce the auto-correlation function, R_{XX}, as follows.

$${R}_{xx} ( τ ) = \frac{1}{T} {\int }_{- T / 2}^{T / 2} x ( t ) x ( t + τ ) ⅆ t \qquad ( 4 )$$

Note that the auto-correlation function is the Fourier transform of the power spectrum; that is:

$${R}_{xx} ( τ ) = \frac{1}{2 π} {\int }_{- {ω}_{th}}^{{ω}_{th}} S ( ω ) {ⅇ}^{- ⅈ ω τ} ⅆ ω . \qquad ( 5 )$$

Also, the second derivative of the auto-correlation function is

$$\frac{{ⅆ}^{2} {R}_{xx} ( τ )}{ⅆ {τ}^{2}} = \frac{1}{2 π} \frac{{ⅆ}^{2}}{ⅆ {τ}^{2}} {\int }_{- {ω}_{th}}^{{ω}_{th}} S ( ω ) {ⅇ}^{- ⅈ ω τ} ⅆ τ . \qquad ( 6 )$$

Thus the second term in I can be written as.

$${{\int }_{- {ω}_{th}}^{{ω}_{th}} {ω}^{2} S ( ω ) ⅆ ω = - 2 π \frac{{ⅆ}^{2} {R}_{xx} ( τ )}{ⅆ {τ}^{2}} \vert}_{τ = 0} = - 2 π {R}_{xx}^{″} ( 0 ) . \qquad ( 7 )$$

Also, the denominator in equation (2) can be written as.

$${I}_{0} = {\int }_{- {ω}_{th}}^{{ω}_{th}} S ( ω ) ⅆ ω = 2 π {R}_{xx} ( 0 ) . \qquad ( 8 )$$

Thus I becomes
I=2πω₀²R_{XX}(0)+2πR_{XX}ⁿ(0) (9)
Combining equation (8) and equation (9) yields:

$$J = \frac{I}{{R}_{xx} ( 0 )} = 2 π {ω}_{0}^{2} + \frac{{R}_{xx}^{″} ( 0 )}{{R}_{xx} ( 0 )} \qquad ( 10 )$$

Hence, the evaluation of the power spectrum distribution reduces to the evaluation of the auto-correlation function.

The above equations were carried out for continuous time signals. Thus adapt equation (10) for discrete time signals. With discrete time signals, the auto-correlation function is written as

$${R}_{xx} ( τ ) = {\sum }_{n} x ( n ) x ( n + τ ) . \qquad ( 11 )$$

In this case, approximate the derivatives by differences:
R_{XX}ⁿ(τ)≈{R_{XX}(τ+1)−R_{XX}(τ)}−{R_{XX}(τ)−R_{XX}(τ−1)} (12)
Thus,
R_{XX}ⁿ(0)≈{R_{XX}(1)−R_{XX}(0)}−{R_{XX}(0)−R_{XX}(−1)}=2(R_{XX}(1)−R_{XX}(0)) (13)
Then J is approximated by

$$J \approx 2 π {ω}_{0}^{2} + 2 ( \frac{{R}_{xx} ( 1 )}{{R}_{xx} ( 0 )} - 1 ) = 2 ( ρ - A ) , \qquad ( 14 )$$

where

$$ρ = \frac{{R}_{xx} ( 1 )}{{R}_{xx} ( 0 )} , A = 1 - {πω}_{0}^{2} . \qquad ( 15 )$$

Here, A is a parameter set by the crossover frequency ω₀, and ρ is the auto-correlation coefficient. Thus evaluation of spectrum distribution metric reduces to computation of the auto-correlation coefficient ρ. If ρ is small (J negative), then the spectrum distribution is primarily in the high frequency region. If ρ is large (J positive), the spectrum distribution lies primarily in the low frequency region.

From FIG. 4, it can be seen that pattern (b) shows large low frequency components and small high frequency components. Therefore, positive ρ means that the signal is close to pattern (b), which shows the largest distortion in DCT-based compression. On the other hand, pattern (c) will show negative ρ. However, pattern (a) may be mistaken as pattern (b), because both may have positive ρ. In order to distinguish pattern (a) from (b), ρ is modified as follows:

$$ρ = \frac{{R}_{xx} ( 1 )}{{R}_{xx} ( 0 ) + δ} . \qquad ( 16 )$$

Here, δ is an arbitrary number smaller than average R_{XX}(0). If R_{XX}(0)>>δ, ρ is the same as the original. If the signal is close to pattern (a) in FIG. 4, its auto-correlation function will be close to zero after removal of the DC component, so ρ will also be near zero due to the δ term. Using this modified value distinguishes pattern (b) from pattern (a) without changing other characteristics. Therefore, the preferred embodiment methods use modified ρ in the following.

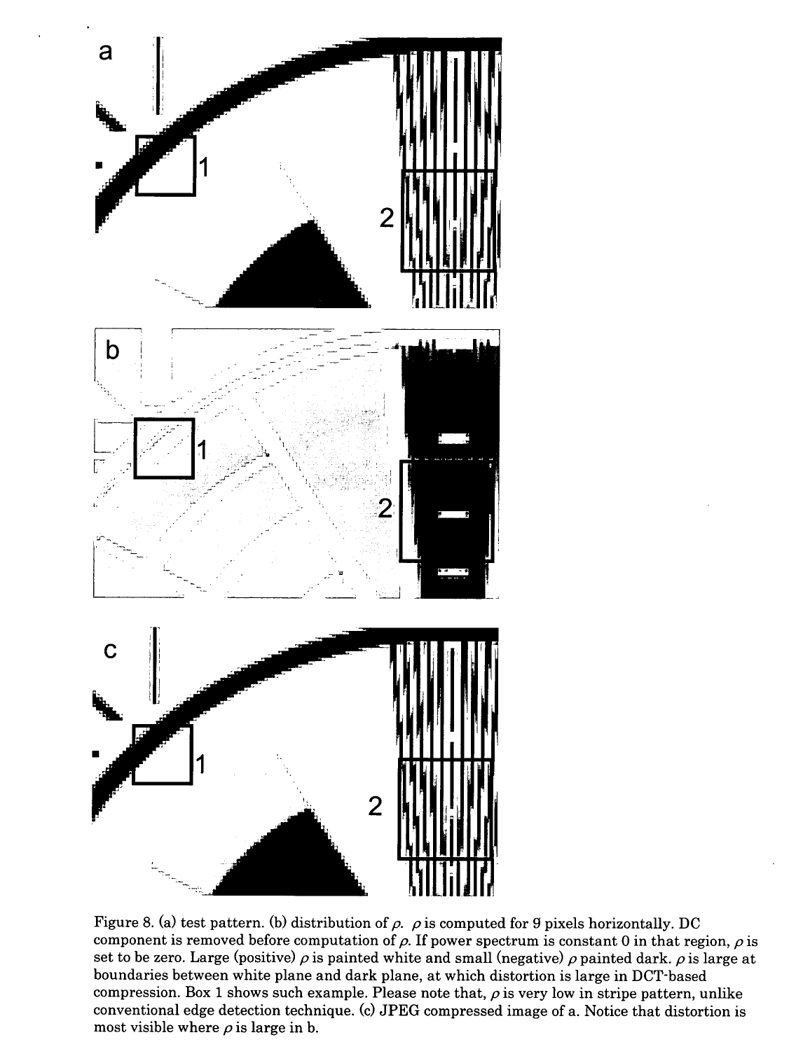

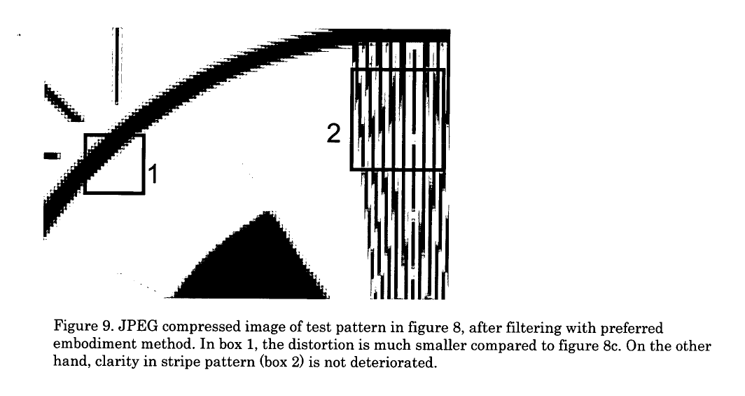

FIGS. 8a-8c provide an example of ρ. FIG. 8a is the original image, and FIG. 8b is the corresponding ρ distribution computed using intervals of nine horizontal pixels about a pixel but with the DC component removed prior to computation. In FIG. 8b, negative ρ is represented by black, and positive ρ white. Note that ρ is positive at the boundary between white plane and dark plane (box 1), while ρ is negative at the stripe (box 2). FIG. 8c shows the JPEG compressed image resulting from the image of FIG. 8a. The positive (white) ρ in FIG. 8b corresponds to artifacts in FIG. 8c, indicating that ρ expresses the likelihood of distortion.

The difference between the preferred embodiment method and the conventional edge detection technique should be emphasized. In the conventional technique, the stripe pattern is considered as a group of edges, just like the boundary between two planes. On the other hand, the preferred embodiment method distinguishes the boundary from the stripe pattern.

In summary, metric p represents the distribution of the power spectrum and represents the likelihood of distortion in DCT-based compression.

4. First Preferred Embodiment

FIG. 1 is a flow diagram of first preferred embodiment image filtering methods which include the following steps.
(1) Compute a modified auto-correlation coefficient, ρ=R_{XX}(1)/(R_{XX}(0)+δ), in the local area near the pixel of interest in the horizontal direction. The area for calculation is determined by the computational level allowed; usually, an interval of 7 to 9 pixels is enough. First, subtract the DC component (the average), and then compute R_{XX}(1) and R_{XX}(0).
(2) Determine the intensity of the filtering according to ρ, so that filtering is applied to places with positive ρ. For example, set the filtering intensity proportional to (ρ−ρₜₕ), where ρₜₕ is a user defined parameter; then apply low pass filtering according to the intensity. More explicitly, start with the simple low pass filter x(n)→y(n)=[x(n−1)+2x(n)+x(n+1)]/4 and then define the overall filtering to be x(n)→(1−i)x(n)+(i)y(n) where the intensity i=5 (ρ−ρₜₕ)/4.
(3) Repeat steps 1 and 2 for each pixel in the image.
(4) Perform steps 1 through 3 for the vertical direction.
   If the image is in color, the filtering is applied to each color. Further; if the image is in Y-U-V or Y-Cr-Cb format, then an alternative would be to only filter the luminance Y.
   5. Experimental

FIG. 9 is a JPEG compressed image of the test pattern in FIG. 8a after filtering with the preferred embodiment method. The pixel values were in the range 0-255, a 9-pixel interval was used for the correlations, δ=64 (if the pixel values were normalized to 0≦x(n)≦1, then δ≈0.001), and ρₜₕ=0.0. The compression ratio is very close to that of FIG. 8c (FIG. 8c: 14.9%, FIG. 9: 14.7%). At boundaries such as the area in box 1, the distortion is suppressed compared to FIG. 8c. However, the stripe in box 2 is still clear.

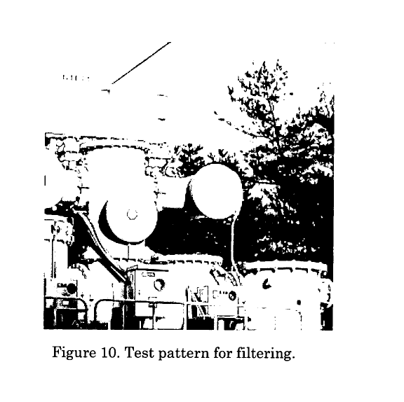

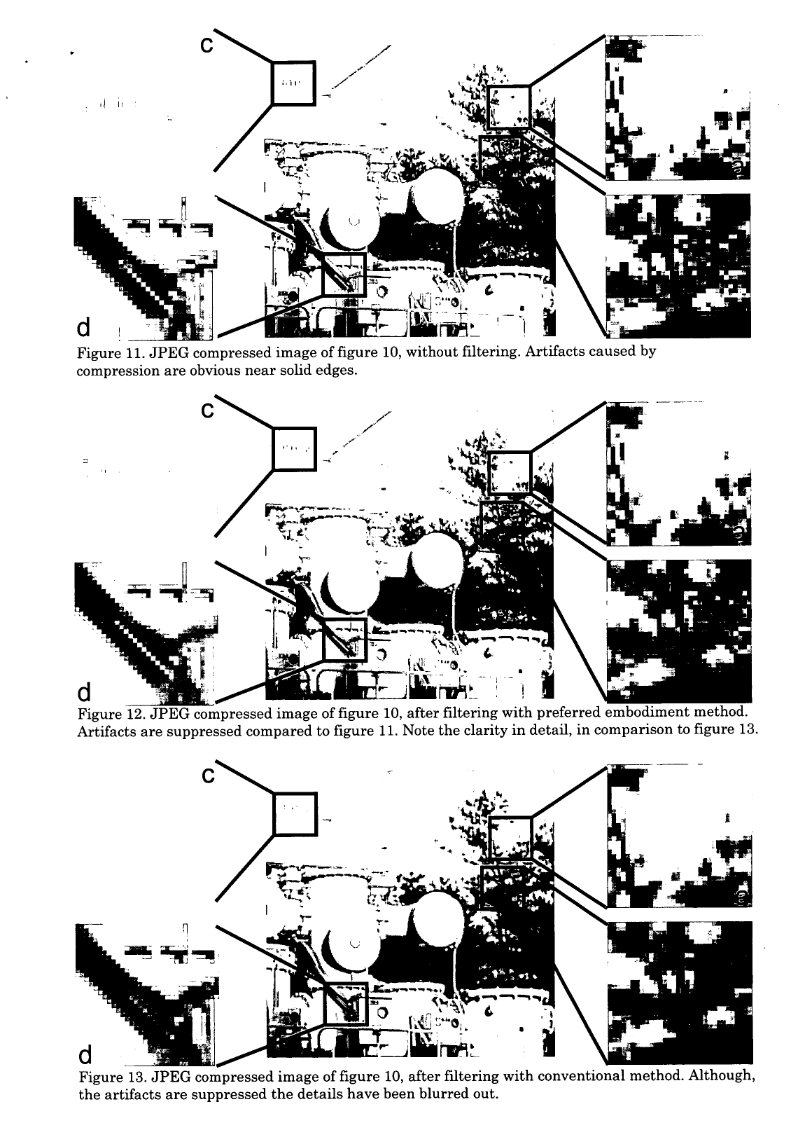

FIG. 10 shows an example of a natural image. FIGS. 11-13 show JPEG compressed images of original image FIG. 10, without pre-processing, with pre-processing using the preferred embodiment method, and with pre-processing using the conventional method, respectively. All three JPEG images have very similar compression ratios (19.3%-19.7%).

FIGS. 12-13 show that, both preferred embodiment and conventional filtering methods reduce artifacts caused by DCT-based compression. However, details are much clearer in the preferred embodiment method. For example, the artifacts near a tree are reduced in both pictures (see FIGS. 12a, 13a). On the other hand, loss in detail clarity is minimal in FIG. 12b (preferred embodiment method), compared to FIG. 13b (conventional method). The pattern of leaves is visible in FIG. 12b; however, it is blurred and not visible in FIG. 13b. FIGS. 12c and 13c also show the same tendency. The artifacts around the plate are reduced in both FIGS. 12c and 13c. However, the letters in FIG. 13c are hardly readable because of blurring, while the letters in FIG. 12c are still clear. FIG. 12d and FIG. 13d show another example. In FIG. 12d the white line in the center is solid; however, in FIG. 13d it is barely observable.

The above results show the superiority of the preferred embodiment method over the conventional linear filtering as a pre-processing technique in DCT-based compression. In short, the preferred embodiment method has following merits.
(a) Reduction of artifacts in DCT-based compression
(b) Preservation of image detail
   6. Modifications

The preferred embodiments may be modified in various ways while retaining one or more of the features of pre-processing filtering derived from modified auto-correlations.

For example, the 7-9 pixel interval size for the auto-correlation could be varied to other sizes. The parameters such as δ, ρₜₕ, and i could be varied. Differing functions f(ω) lead to replacing ρ with other combinations of derivatives of the auto-correlation; and so forth.

1. A method of image filtering, comprising:
(a) computing a modified auto-correlation in a first direction for each pixel in an image;
(b) filtering said image with a lowpass filter; and
(c) interpolating said image and said filtered image from step (b) wherein said interpolating at said each pixel depends upon said modified auto-correlation in a first direction.

2. The method of claim 1, further comprising:
(a) after steps (a)-(c) of claim 1 repeating steps (a)-(c) of claim 1 with said first direction replaced by a second direction, said second direction perpendicular to said first direction; and with said image of step (c) replaced by said interpolated image using said modified auto-correlation in a first direction.

3. The method of claim 1, wherein:
(a) said modified auto-correlation of step (a) of claim 1 is R_{XX}(1)/(R_{XX}(0)+δ) where R_{XX}(.) is the auto-correlation function for the pixel values in an interval about said each pixel and with the DC component removed, and where δ is a parameter.

4. The method of claim 3, wherein:
(a) said interpolating of step (c) of claim 1 depends upon the amount R_{XX}(1 )/(R_{XX}(0)+δ) of claim 3 exceeds a threshold.

5. The method of claim 1, wherein:
(a) said image is a color channel of a color image.
